(19) United States
(12) Patent Application Publication
(10) Pub. No.: US 2014/0071023 A1
(43) Pub. Date: Mar. 13, 2014

(54) DISPLAYING METHOD AND PORTABLE DEVICE

(71) Applicant: E Ink Holdings Inc., Hsinchu (TW)

(72) Inventor: Chun-Wei Chu, Hsinchu (TW)

(73) Assignee: E Ink Holdings Inc., Hsinchu (TW)

(21) Appl. No.: 13/949,247

(22) Filed: Jul. 24, 2013

Related U.S. Application Data
(60) Provisional application No. 61/697,813, filed on Sep. 7, 2012.

(30) Foreign Application Priority Data
Mar. 26, 2013 (TW) 102110699

(51) Int. Cl. G06F 3/14

(52) U.S. Cl. CPC G06F 3/1423
USPC 345/3.1

(57) ABSTRACT

A displaying method for a portable device having a first surface and a second surface opposite to the first surface is provided. The portable device includes a first display device configured on the first surface, and a detachable rear cover covers the second surface. A second display device is configured on the detachable rear cover. In the displaying method, a function launching signal is received to execute a function corresponding to the signal, and a frame corresponding to the executed function is displayed on the first display device. An input signal is received to select a portion of the frame, and the selected portion of the frame is transmitted to the second display device. The selected portion of the frame is displayed on the second display device.

### CROSS-REFERENCE TO RELATED APPLICATION

This application claims the priority benefit of U.S. Provisional Application Ser. No. 61/697,813, filed on Sep. 7, 2012. This application also claims the priority benefit of Taiwan application serial no. 102110699, filed on Mar. 26, 2013. The entirety of each of the above-mentioned patent applications is hereby incorporated by reference herein and made a part of this specification.

### BACKGROUND OF THE INVENTION

1. Field of the Invention

The invention relates to a displaying method and a portable device; particularly, the invention relates to a multi-screen displaying method and a portable device.

2. Description of Related Art

With the continuous development of functionalities and convenience of mobile devices, such as smart phones or tablet computers, the mobile devices have become the indispensible electronic products in modern daily lives. Users not only utilize the mobile devices to share information or chat online anytime but also install various applications into the mobile devices to obtain a variety of services by executing the applications.

However, most of the existing mobile devices (e.g., the smart phones or the tablet computers) on the market are unable to split one frame into multiple blocks and respectively display different contents of the blocks on different display devices. From another perspective, the display devices configured in the mobile devices are mostly liquid crystal displays (LCD) or light emitting diode (LED) displays covered by transparent glass materials; therefore, once the barcodes (e.g., one-dimensional barcodes) displayed on the displays are scanned by laser beams, the glass materials may cause light reflection, thus resulting in misinterpretation of the scanned barcodes. As a result, it is rather difficult for the display devices configured in the existing mobile devices to display tickets, coupons, or documents that require barcode authentication.

### SUMMARY OF THE INVENTION

The invention is directed to a displaying method and a portable device, whereby a user is able to determine the contents to be displayed on different display devices, and barcodes are likely to be displayed on the display devices without raising the issue of misinterpretation of the scanned barcodes.

In an embodiment of the invention, a displaying method for a portable device having a first surface and a second surface opposite to the first surface is provided. The portable device includes a first display device that is configured on the first surface, and a detachable rear cover covers the second surface. A second display device is configured on the detachable rear cover. In the displaying method, a function launching signal is received to execute a function corresponding to the function launching signal, and a frame corresponding to the executed function is displayed on the first display device. An input signal is received to select a portion of the frame, and the selected portion of the frame is transmitted to the second display device. The selected portion of the frame is displayed on the second display device.

According to an embodiment of the invention, in the displaying method, the selected portion of the frame includes a one-dimensional barcode image, a ticket or coupon image, an advertisement image, a text paragraph, or an identification image.

According to an embodiment of the invention, in the displaying method, the second display device includes an electronic paper display device.

According to an embodiment of the invention, in the displaying method, the second display device receives the selected portion of the frame through a cable connection or a wireless connection.

According to an embodiment of the invention, before transmitting the selected portion of the frame to the second display device, the displaying method further includes a step of receiving a determination signal to determine that the selection portion of the frame is transmitted to the second display device.

In an embodiment of the invention, a portable device having a first surface and a second surface opposite to the first surface is provided. A detachable rear cover covers the second surface, and a second display device is configured on the detachable rear cover. The portable device includes a first display device and a processor. The first display device is configured on the first surface. The processor is coupled to the first display device and the second display device. Here, the processor: receives a function launching signal to execute a function corresponding to the function launching signal and displays a frame corresponding to the executed function on the first display device; receives an input signal to select a portion of the frame and transmits the selected portion of the frame to the second display device; displays the selected portion of the frame on the second display device.

According to an embodiment of the invention, in the portable device, the selected portion of the frame includes a one-dimensional barcode image, a ticket or coupon image, an advertisement image, a text paragraph, or an identification image.

According to an embodiment of the invention, in the portable device, the second display device includes an electronic paper display device.

According to an embodiment of the invention, in the portable device, the second display device receives the selected portion of the frame through a cable connection or a wireless connection.

According to an embodiment of the invention, in the portable device, before the processor transmits the selected portion of the frame to the second display device, the processor receives a determination signal to determine that the selection portion of the frame is transmitted to the second display device.

In view of the above, the portable device described herein may be equipped with a detachable rear cover that has a display device, and the detachable rear cover may be employed together with the portable device or may be independently utilized. A user may determine the contents to be displayed on the detachable rear cover; the contents include: electronic tickets, coupons, electronic bus, train, airplane, or cruise ship tickets, admission tickets for ballgames, concerts, restaurants or bars, coffee shops, shopping centers, or exhibitions, personal identification cards (ID), exhibition IDs, or show IDs, bills, receipts, or invoices, advertisements, market researches, promotion documents, discounts, or pictures, books/mails/remaining battery power/time/weather/maps/schedules/incoming calls/any other contents or messages in the portable device. In another aspect, the display device configured on the detachable rear cover may be the electronic paper display device, and hence the issue of misinterpretation of barcodes caused by light reflection occurring when a normal laser scanner scans the LCD may be resolved. Since manufacturers need not spend a significant amount of money on replacing the normal, existing laser scanners, costs and time may both be economized.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a brief diagram schematically illustrating a portable device according to an embodiment of the invention.

FIG. 2 is brief diagram schematically illustrating a portable device and a detachable rear cover of the portable device according to an embodiment of the invention.

FIG. 3 is a brief flowchart illustrating a displaying method according to an embodiment of the invention.

FIG. 4 is a brief flowchart illustrating a displaying method according to an embodiment of the invention.

### DETAILED DESCRIPTION OF DISCLOSED EMBODIMENTS

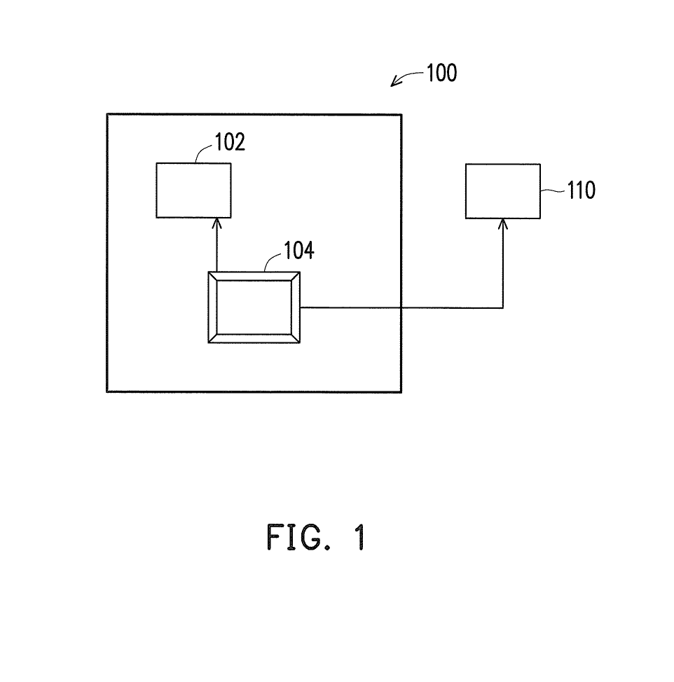

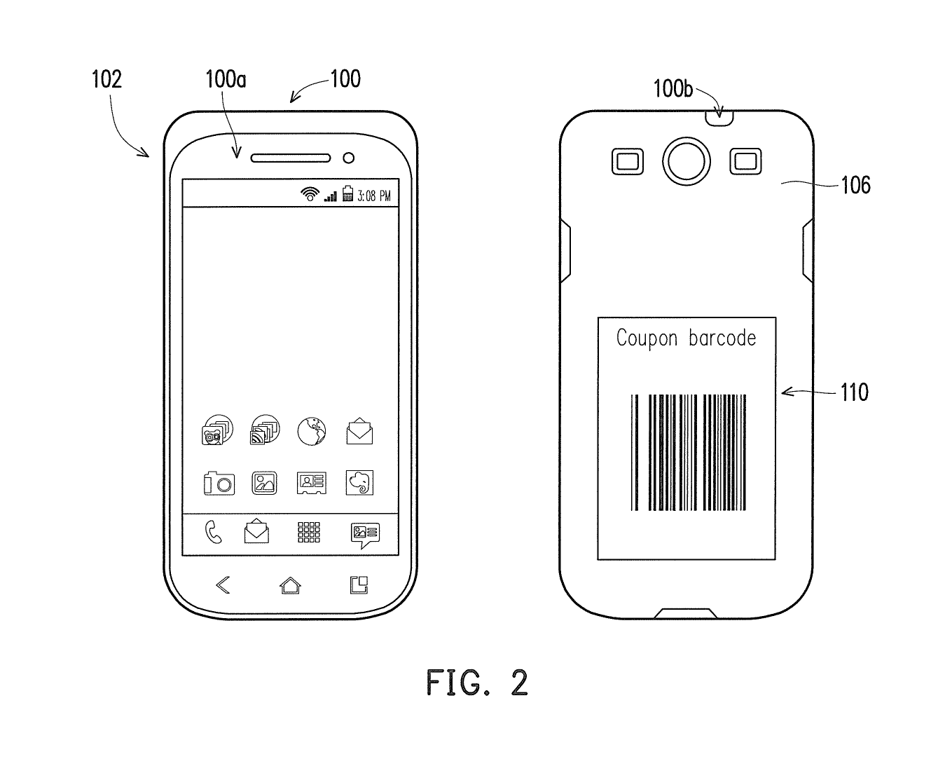

FIG. 1 is a brief diagram schematically illustrating a portable device according to an embodiment of the invention. FIG. 2 is brief diagram schematically illustrating a portable device and a detachable rear cover of the portable device according to an embodiment of the invention. With reference to FIG. 1 and FIG. 2, the portable device 100 described in the present embodiment includes a first surface 100a and a second surface 100b opposite to the first surface 100a. Here, the portable device 100 is, for instance, a cell phone, a personal digital assistant (PDA), a smart phone, an electronic book, a game machine, a tablet PC, or any other portable device, which should however not be construed as a limitation to the invention.

The portable device 100 also includes a first display device 102 and a processor 104. The first display device 102 is configured on the first surface 100a of the portable device 100; the processor 104 is coupled to the first display device 102. Here, the first display device 102 is, for instance, an electronic paper display device, an LCD, an organic light emitting diode (OLED) display, a bistable display, or an LED display. The processor 104 is, for instance, a micro-controller, an embedded controller, or a central processing unit (CPU).

A detachable rear cover 106 covers the second surface 100b opposite to the first surface 100a of the portable device 100, and a second display device 110 is configured on the detachable rear cover 106. The second display device 110 is configured corresponding to the first display device 102. The detachable rear cover 106 may be made of any material (e.g., plastic or rubber) and may be detachably fixed to the portable device 100 in form of tenon, so as to cover the second surface 100b. Besides, the detachable rear cover 106 is, for instance, a flip-open protection rear cover that covers the entire portable device 100 or a protection rear cover that covers a portion of the portable device 100, such that the second surface 100b of the portable device 100 may be covered by the detachable rear cover 106. Here, the second display device 110 is, for instance, an electronic paper display device, an LCD, an OLED display, a bistable display, or an LED display, and the second display device 110 may be assembled or adhered to the detachable rear cover 106. In addition, the second display device 110 receives a display signal from the processor 104 through a cable connection or a wireless connection, for instance, so that the second display device 110 may display a frame. For instance, the second display device 110 may be coupled to the processor 104 of the portable device 100 through the detachable rear cover 106 and a physical cable. In another embodiment, the second display device 110 may include a wireless communication interface, such that the second display device 110 may be coupled to the processor 104 in a wireless manner and may receive the display signal from the processor 104.

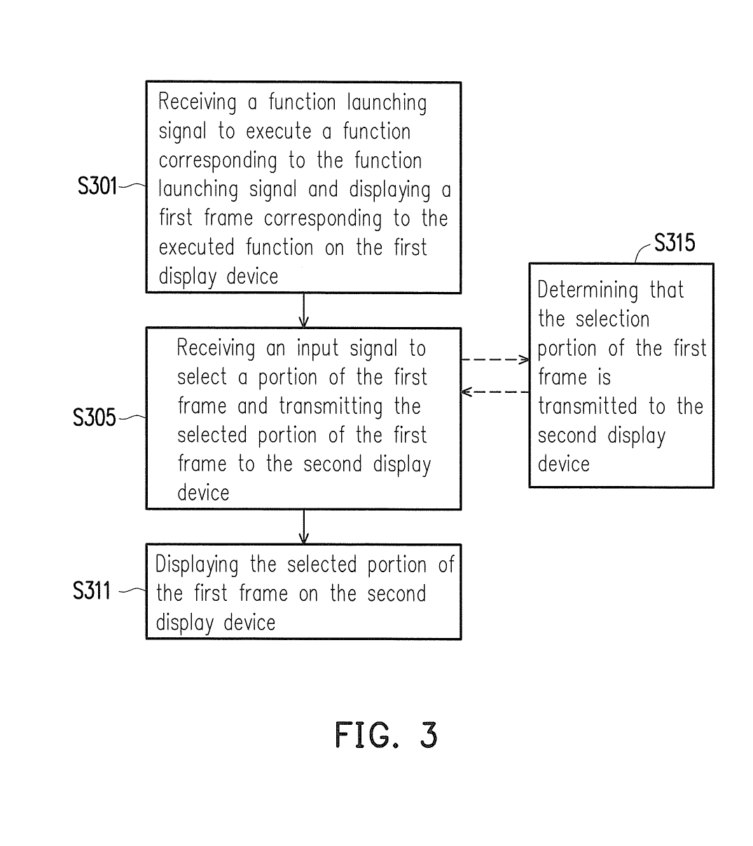

FIG. 3 is a brief flowchart illustrating a displaying method according to an embodiment of the invention. With reference to FIG. 1, FIG. 2, and FIG. 3, the displaying method described in the present embodiment is suitable for the aforesaid portable device 100. In step S301 of the displaying method, the processor 104 receives a function launching signal to execute a function corresponding to the function launching signal, and the processor 104 displays a frame corresponding to the executed function on the first display device.

In step S305, the processor 104 receives an input signal to select a portion of the frame and transmits the selected portion of the frame to the second display device. The selected portion of the frame may be a one-dimensional barcode image, a ticket or coupon image, an advertisement image, a text paragraph, or an identification image, for instance. In step S311, the processor 104 displays the selected portion of the frame on the second display device.

According to an embodiment of the invention, in the step S305, before the processor 104 transmits the selected portion of the frame to the second display device, the processor 104 receives a determination signal to determine that the selection portion of the frame is transmitted to the second display device (step S315).

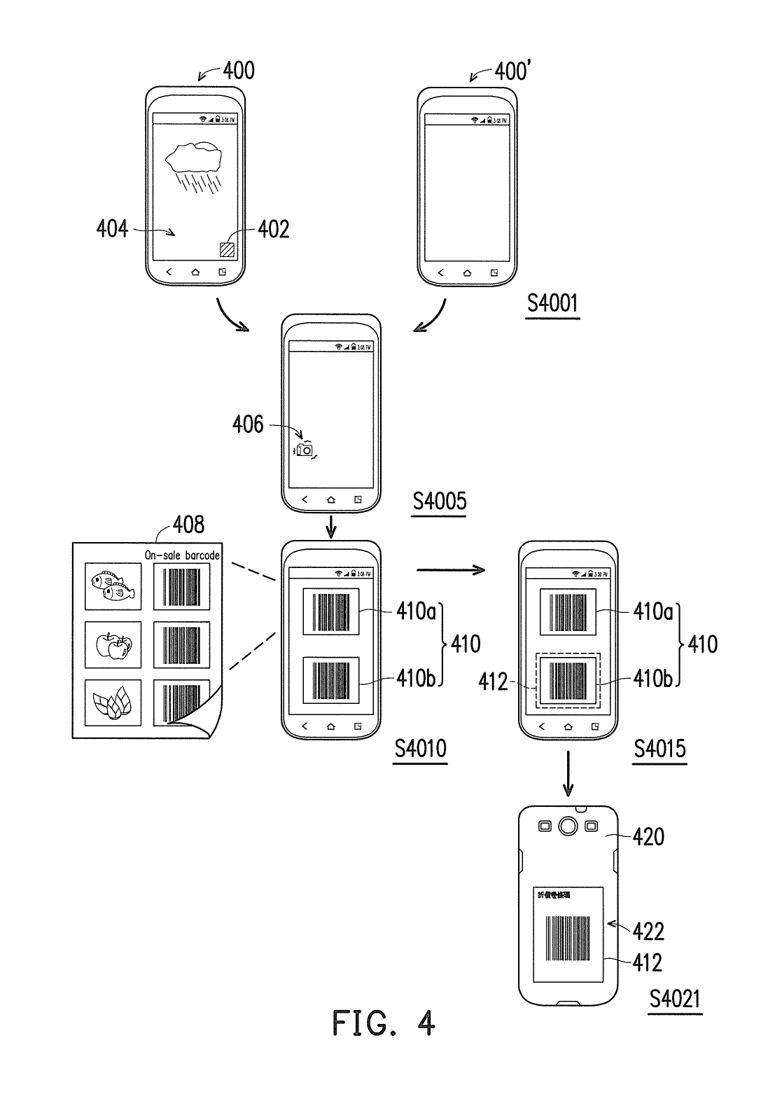

An embodiment is provided hereinafter together with a drawing sheet to further elaborate the displaying method suitable for a multi-screen portable device. FIG. 4 is a brief flowchart illustrating a displaying method according to an embodiment of the invention. With reference to FIG. 4, according to the multi-screen displaying method described herein, a processor of a portable device 400 may execute a display application program (step S4001), for instance. The display application program is represented by an image 402 that is displayed on the homepage 404 of the portable device or in the selection menu (not shown) of the application program, and a user may click on the image 402, such that the processor of the portable device 400 is allowed to execute the display application program represented by (corresponding to) the image 402. In another embodiment, the display application program may also run in the background of the portable device 400′ (i.e., the display application program is executed in background of the portable device, while no frame indicating the execution of any application program is displayed on the first display device).

In step S4005, the processor (e.g., the processor 104 shown in FIG. 1) receives a function launching signal generated by the user, so as to launch the image 406 (e.g., an image corresponding to a photo-shooting function) displayed on the first display device. In step S4010, the user performs the photo-shooting function corresponding to the image 406 to take a picture of an object (e.g., an advertisement flyer 408) and capture a frame 410 which exemplarily includes on-sale barcodes 410a and 410b. In step S4015, the user generates an input signal to select a partial frame 412 of the frame 410 including the barcode 410b; in step S4021, the processor displays the selected partial frame 412 (including the barcode 410b) on the second display device 422 on the detachable rear cover 420.

To sum up, the portable device described herein may be equipped with a detachable rear cover that has a display device, and the detachable rear cover may be employed together with the portable device or may be individually utilized. A user may determine the contents to be displayed on the detachable rear cover; the contents include: electronic tickets, coupons, electronic bus, train, airplane, or cruise ship tickets, admission tickets for ballgames, concerts, restaurants or bars, coffee shops, shopping centers, or exhibitions, personal identification cards (ID), exhibition IDs, or show IDs, bills, receipts, or invoices, advertisements, market researches, promotion documents, discounts, or pictures, books/mails/remaining battery power/time/weather/maps/schedules/incoming calls/any other contents or messages in the portable device. In another aspect, the display device configured on the detachable rear cover may be the electronic paper display device, and hence the issue of misinterpretation of barcodes caused by light reflection occurring when a normal laser scanner scans the LCD may be resolved. Since manufacturers need not spend a significant amount of money on replacing the normal, existing laser scanners, costs and time may both be economized.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A displaying method for a portable device having a first surface and a second surface opposite to the first surface, the portable device comprising a first display device configured on the first surface, a detachable rear cover covering the second surface, a second display device being configured on the detachable rear cover, the displaying method comprising:
receiving a function launching signal to execute a function corresponding to the function launching signal, and displaying a frame corresponding to the executed function on the first display device;
receiving an input signal to select a portion of the frame, and transmitting the selected portion of the frame to the second display device; and
displaying the selected portion of the frame on the second display device.

2. The displaying method as recited in claim 1, wherein the selected portion of the frame comprises a one-dimensional barcode image, a ticket or coupon image, an advertisement image, a text paragraph, or an identification image.

3. The displaying method as recited in claim 1, wherein the second display device comprises an electronic paper display device.

4. The displaying method as recited in claim 1, wherein the second display device receives the selected portion of the frame through a cable connection or a wireless connection.

5. The displaying method as recited in claim 1, before transmitting the selected portion of the frame to the second display device, further comprising receiving a determination signal to determine that the selection portion of the frame is transmitted to the second display device.

6. A portable device having a first surface and a second surface opposite to the first surface, a detachable rear cover covering the second surface, a second display device being configured on the detachable rear cover, the portable device comprising:
a first display device configured on the first surface; and
a processor coupled to the first display device and the second display device, wherein the processor:
receives a function launching signal to execute a function corresponding to the function launching signal and displays a frame corresponding to the executed function on the first display device;
receives an input signal to select a portion of the frame and transmits the selected portion of the frame to the second display device; and
displays the selected portion of the frame on the second display device.

7. The portable device as recited in claim 6, wherein the selected portion of the frame comprises a one-dimensional barcode image, a ticket or coupon image, an advertisement image, a text paragraph, or an identification image.

8. The portable device as recited in claim 6, wherein the second display device comprises an electronic paper display device.

9. The portable device as recited in claim 6, wherein the second display device receives the selected portion of the frame through a cable connection or a wireless connection.

10. The portable device as recited in claim 6, wherein before the processor transmits the selected portion of the frame to the second display device, the processor receives a determination signal to determine that the selection portion of the frame is transmitted to the second display device.
